(19) United States
(12) Patent Application Publication
(10) Pub. No.: US 2013/0151125 A1
(43) Pub. Date: Jun. 13, 2013

(54) Apparatus and Method for Controlling Emissions in an Internal Combustion Engine

(71) Applicants: Scott K. Mann, Jefferson, WI (US); Jared J. Wentz, Wauwatosa, WI (US)

(72) Inventors: Scott K. Mann, Jefferson, WI (US); Jared J. Wentz, Wauwatosa, WI (US)

(21) Appl. No.: 13/314,427

(22) Filed: Dec. 8, 2011

(51) Int. Cl. F02D 41/00

(52) U.S. Cl. 701/109

(57) ABSTRACT

Certain embodiments of methods and systems for operating an internal combustion engine over a range of operating condition are disclosed. One embodiment of a method includes operating the engine at an initial O2 voltage setpoint; and automatically adjusting the O2 voltage setpoint to a new O2 voltage setpoint to reduce emissions. In certain embodiments a control system for controlling emissions in an internal combustion is provided. The control system includes at least one subsystem that controls an O2 voltage setpoint; at least one subsystem that measures NOx emissions in the engine exhaust; and at least one subsystem that initiates a lambda sweep to determine an optimal O2 voltage setpoint.

### TECHNICAL FIELD

The subject matter disclosed herein relates to emissions control in internal combustion engine and more particularly to the control of CO and NOx emissions in an internal combustion engine.

### BACKGROUND

Internal combustion engines are ideally operated in a way that the combustion mixture contains air and fuel in the exact relative proportions required for a stoichiometric combustion reaction. A rich burn engine may operate with a stoichiometric amount of fuel or a slight excess fuel, while a lean-burn engine operates with excess oxygen (O₂) compared to the amount required for stoichiometric combustion. The operation of an internal combustion engine in lean mode may reduce throttling losses and can take advantage of higher compression ratios thereby providing improvements in performance and efficiency. Rich burn engines, on the other hand are relatively simple, reliable and stable, and adapt well to changing loads.

In order to comply with emissions standards, many rich burn internal combustion engines utilize non-selective catalytic reduction (NSCR) subsystems also known as 3-way catalyst. These subsystems reduce emissions of nitrogen oxides NO and NO₂ (collectively NOx), carbon monoxide (CO) and volatile organic compounds (VOC), along with other regulated emissions. 3-way catalysts have high reduction efficiencies and are economical but require tight control of the air fuel ratio of the engine in order to meet emissions standards. These standards are sometimes stated in terms of grams of emissions per brake horsepower hour (g/bhp-hr).

Previously, rich burn emissions control with a catalyst was only possible using O₂ sensing at both the input and output locations of the catalyst subsystem. In those systems a control subsystem adjusted the air fuel ratio continuously to maintain a constant O₂ content in the exhaust. The target value for the constant O₂ content (the O₂ voltage setpoint) was static. Occasionally, these control systems allowed greater variation of emissions than is optimal over varying operating and environmental conditions as well as shifts in the catalyst operating window. The reason is that to reach low NOx and CO emissions levels one cannot simply set the O₂ voltage setpoint to a single value. The optimal O₂ voltage setpoint for emissions compliance varies depending on load, speed, ambient conditions, among other conditions.

### BRIEF DESCRIPTION OF THE INVENTION

According to one aspect of the invention, a method of operating an internal combustion engine over a range of operating conditions, the internal combustion engine having at least one O₂ sensor is provided. The method of this aspect includes operating the engine at an initial O2 voltage setpoint and automatically adjusting the O2 voltage setpoint to a new O2 voltage setpoint to reduce emissions.

According to another aspect of the present invention a system for improving emission performance of an internal combustion engine over a range of operating conditions is provided. The system of this aspect includes a catalyst subsystem for treating exhaust from the internal combustion engine; an O2 sensor disposed upstream from the catalyst subsystem; and a NOx sensor disposed in the exhaust. The system of this aspect also includes a control subsystem that receives data from the O2 sensor and the NOx sensor, and automatically adjusts an O2 voltage setpoint to a new voltage setpoint to reduce emissions.

According to another aspect of the present invention, a control system for controlling emissions in an internal combustion engine exhaust is provided. The control system of this aspect includes at least one subsystem that controls an O2 voltage setpoint; at least one subsystem that measures NOx emissions in the engine exhaust; and at least one subsystem that initiates a lambda sweep to determine an optimal O2 voltage setpoint.

According to another aspect of the present invention, a method for controlling emissions in an internal combustion engine exhaust is provided. The method of this aspect includes measuring NOx emissions; initiating a lambda sweep to determine an O2 voltage setpoint at which NOx emissions at the new operating condition comply with NOx emissions standards; and operating the internal combustion engine at the new O2 voltage setpoint.

According to another aspect of the present invention, computer-readable media is provided. The computer readable media of this aspect provides instructions that, when executed by a control module that controls emissions in an internal combustion engine exhaust, cause the control module to measure NOx emissions; initiate a lambda sweep to determine an O2 voltage setpoint at which NOx emissions at the new operating condition comply with NOx emissions standards; and operate the internal combustion engine at the new O2 voltage setpoint.

### BRIEF DESCRIPTION OF THE DRAWINGS

The following description of the Figures is not intended to be, and should not be interpreted to be, limiting in any way.

FIG. 1 is a diagram of an example of an internal combustion engine system in accordance with an embodiment.

FIG. 2 is a chart illustrating the impact of operating conditions on a NOx compliance window.

FIG. 3 is a flowchart showing a process of an embodiment.

FIG. 4 is a chart illustrating the principle of operation of an embodiment.

FIG. 5 is a flowchart showing a process of an embodiment.

FIG. 6 is a chart illustrating the principle of operation of an embodiment.

### DETAILED DESCRIPTION OF THE INVENTION

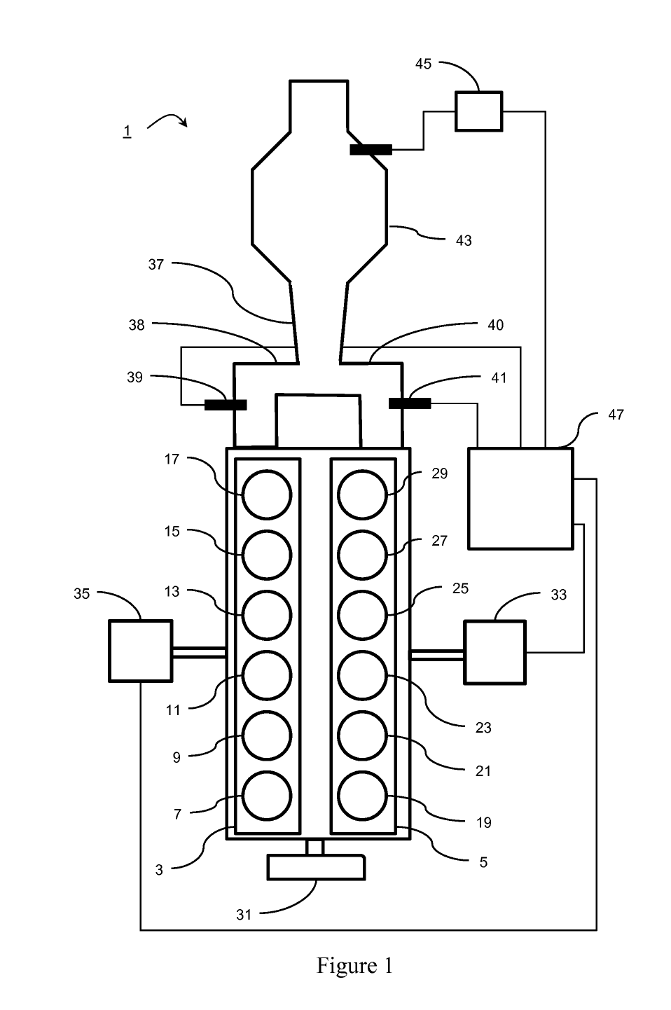

Illustrated in FIG. 1 is an internal combustion engine system 1 with improved emissions control capabilities according to one embodiment of the present invention. The internal combustion engine system 1 includes a left cylinder bank 3 and a right cylinder bank 5. The left cylinder bank 3 includes a plurality of cylinders 7, 9, 11, 13, 15, and 17. The right cylinder bank 5 includes a plurality of cylinders, 19, 21, 23, 25, 27 and 29. Although the internal combustion engine system 1 in this embodiment is illustrated with 12 cylinders, any number of cylinders, (1, 2, 4, 8, 14, 16 etc.) may be used. The internal combustion engine system 1 also includes a fly wheel 31.

The internal combustion engine system 1 also includes a right regulator 33 associated with the right cylinder bank 5, and a left regulator 35 associated with the left cylinder bank 3. The right regulator 33 controls the flow of air and fuel to the right cylinder bank 5, and the left regulator 35 controls the flow of air and fuel to the left cylinder bank 3. A regulator is a device that determines and maintains the operating parameters of a system, usually within certain prescribed or preset limits. The right regulator 33 and left regulator 35 adjust the air fuel ratio in the right cylinder bank 5 and the left cylinder bank 3 respectively. Although the embodiment illustrated in FIG. 1 refers to a regulator, any device or combination of devices that can be used to control the air fuel ratio may be included, such as for example electronic fuel injection devices, carburetors, and the like.

Associated with the right cylinder bank 5 and the left cylinder bank 3 is a manifold 37 that conveys the exhaust gases from internal combustion engine system 1. The manifold 37 includes a left manifold tube 38 into which is placed at least one left O₂ sensor 39, and a right manifold tube 40 into which is placed at least one right O₂ sensor 41. The left O₂ sensor 39 and right O₂ sensor 41 (also known as lambda sensors) are electronic devices that measure the proportion of O₂ in the exhaust inside the manifolds 38, 40 and determine, in real time, if the air fuel ratio of a combustion engine is rich or lean. Information from the left O₂ sensor 39 and the right O₂ sensor 41 may be used to indirectly determine the air fuel ratio. In some embodiments only one O₂ sensor may be used. Among the types of O₂ sensors available are concentration cell (zirconia sensors), oxide semiconductor (TiO₂ sensors) and electrochemical O₂ sensors (limiting current sensors). The sensors do not typically measure O₂ concentration directly, but rather the difference between the amount of O₂ in the exhaust gas and the amount of O₂ in a reference sample. Rich mixtures cause an O₂ demand. This demand results in a build-up of voltage due to transportation of O₂ ions through a sensor layer. Lean mixture result in low voltage, since there is an O₂ excess.

Exhaust gases from the internal combustion engine system 1 are conveyed through the right manifold tube 40 and the left manifold tube 38 into a catalytic chamber 43 that contains a catalyst for the reduction of NOx and CO emissions. In a preferred embodiment the catalyst may be a 3-way catalyst commonly used for internal combustion engine applications. The catalyst converts CO, NOx and VOC emissions through reduction and oxidation to produce carbon dioxide, nitrogen, and water. Three-way catalysts are effective when the engine is operated within a narrow band of air-fuel ratios near stoichiometry. The conversion efficiency of the catalyst declines significantly when the engine is operated outside of that band of air-fuel ratios. Under lean engine operation, there is excess O₂ and the reduction of NOx is not favored. Under rich conditions, excess fuel consumes all of the available O₂ in the exhaust prior to the catalyst, thereby making oxidation reactions less likely.

A NOx sensor 45 is disposed downstream from the catalytic chamber 43. In alternative embodiments, the NOx sensor may be located upstream of the catalytic chamber 43 (if a catalyst is used), or multiple NOx sensors may be used. NOx sensors are devices that detect nitrogen oxides in combustion environments such as internal combustion engine system 1. A variety of different sensors are available for adaptation to use in an internal combustion engine system 1. For example, there are a variety of solid-state electrochemical sensors including solid electrolyte (potentiometric and amperometric) and semiconducting types.

The NOx sensor 45, right O₂ sensor 41 and left O₂ sensor 39, right regulator 33 and left regulator 35 are all coupled to an emission control module 47. The emission control module 47 may be provided as a microprocessor and a memory, or as software otherwise provided or embedded within other processors or electronic systems associated with the internal combustion engine system 1 or in any other known forms. Emissions control module 47 in various embodiments may include instructions executable by one or more computing devices. Such instructions may be compiled or interpreted from computer programs created using a variety of known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

The internal combustion engine system 1 with improved emissions control capabilities may be operated over a range of operating conditions by automatically adjusting a setpoint of one or more O₂ sensors, such as left O₂ sensor 30, right O₂ sensor 41, or both. An O₂ voltage setpoint is the target value for O₂ that the emission control module 47 will aim to reach by controlling the amount of fuel that enters the engine relative to the amount of air. The amount of fuel that enters the engine relative to air is called the air fuel ratio (AFR), and sometimes expressed as Lambda (λ) which is the engine's AFR relative to a stoichiometric AFR. The internal combustion engine system 1 accomplishes an improved emissions performance by adjusting the pre-catalyst O₂ voltage setpoints from a calibrated high setpoint at a calibrated sweep rate downwards to a low O₂ voltage setpoint until NOx measurements become unstable or spike (i.e. stability level threshold is breached). In one embodiment, stability may be determined by measuring NOx concentration over a given period of time.” The sweep rate may be in milli-volts per second and may be specifically calibrated for each engine. Once the stability threshold is breached the O₂ voltage setpoint is adjusted upward at a calibrated sweep rate until the stability level is achieved (NOx readings NOX sensor 45 become stable again).

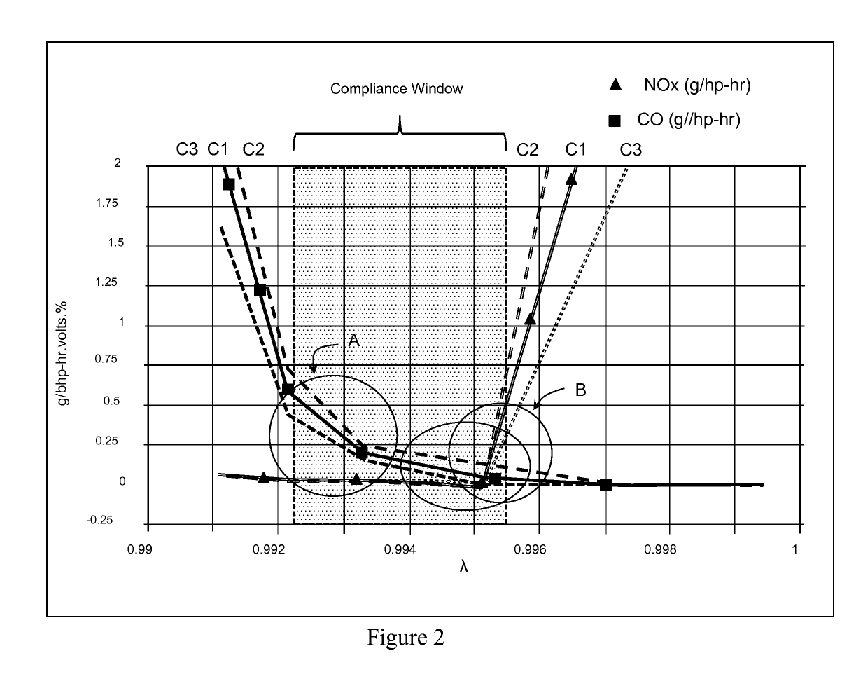

The principles behind the process for automatically adjusting the setpoints is best understood with reference to FIG. 2. FIG. 2 illustrates a typical catalyst window characteristic in respect to NOx and CO emissions in a rich burn engine. In the chart, emissions measured in g/bhp-hr.volts are plotted against λ. In Stoichiometric mixtures λ=1, in rich mixtures λ<1, and in lean mixtures λ>1.

On the right-hand side of the chart in FIG. 2, values for NOx emissions for a specific set of conditions C1 are illustrated by a continuous double line with superimposed triangles. On the left-hand side of the chart values for CO emissions for condition C1 are illustrated as a solid line with superimposed rectangles. A compliance window is represented by a shaded rectangular area. Highlighted with a circle denoted as A is the area where CO emissions begin to rise rapidly as lambda is decreased. This is referred to as the rich knee of the lambda curve. Highlighted with a circle denoted as B is the area where NOx emissions begin to rise rapidly as the lambda values increase. This is referred to as the lean knee of the lambda curve. The preferred operation window usually resides between the rich knee and the lean knee of the lambda curve.

When, for example, engine load, fuel quality, or engine ambient conditions change, conditions C1 may shift as shown in C2, C3, or shift in other ways. When conditions change from conditions C1 to conditions C2 the area between the NOx curve (shown as dashed double lines on the right hand side of the chart) and the CO curve (shown as solid double lines on the left hand side of the chart) narrows. When conditions change from conditions C1 to conditions C3 the area between the NOx curve and the CO curve widens. Additionally, with changing conditions the NOx and CO curves may be shifted left or right. This phenomenon makes it very difficult to control emissions with a static O₂ voltage setpoint.

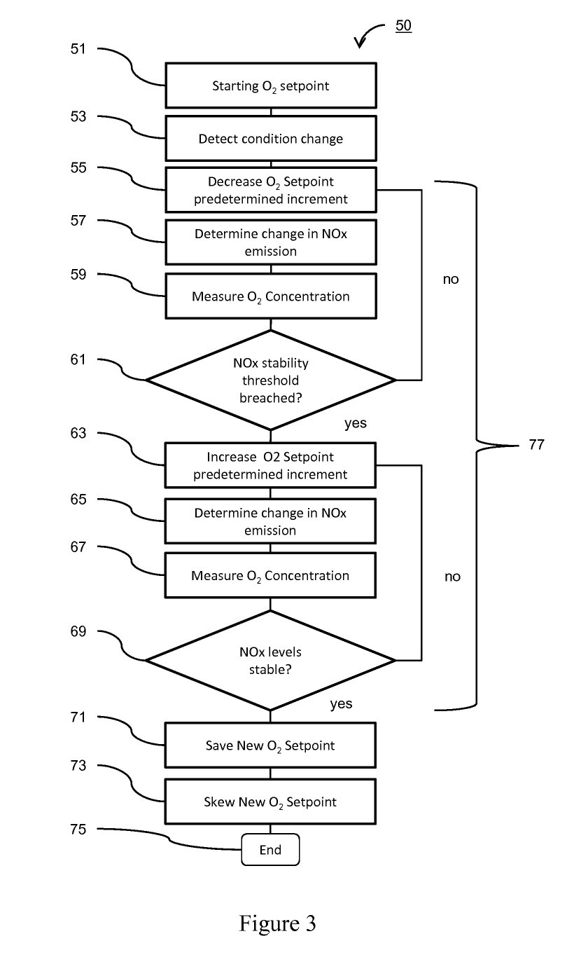

FIG. 3 illustrates an embodiment of a method for setting a new O₂ voltage setpoint for NOx compliance 50. The internal combustion engine system 1 is in operation with a starting O₂ voltage setpoint (method element 51). A change of condition is detected (method element 53), such as, for example, a change in the load, a change in the operating speed, a change in ambient conditions, elapsing of a specified time increment, and the like. At that point the emission control module 47 instructs a decrease of the O₂ voltage setpoint by a predetermined increment. The incremental decrease of the O₂ voltage setpoint may be determined from a calibrated sweep rate determined for each internal combustion engine system 1. The calibrated sweep rate may be determined for the engine based on the period of time required for the O₂ sensor(s) (left O₂ sensor 39, right O₂ sensor 41, or both) and the NOx sensor 45 to be stabilized. NOx emissions and O₂ concentrations may then be measured (method elements 57 and 59). A determination of whether the NOx stability threshold has been breached is then made (method element 61) based on the values from method element 57. If the NOx stability threshold has not been breached then the O₂ voltage setpoint may be decreased again by a predetermined amount (method element 55). Once the NOx stability threshold is breached, the O₂ voltage setpoint may be increased by a predetermined increment (method element 63). A determination of the change in NOx emissions may then be made (method element 65) and the O₂ concentration may be measured (method element 67). A determination may then be made as to whether the NOx levels have become stable (i.e. the rate of change of NOx levels as close to 0), (method element 69). If the NOx levels are not stable the O2 voltage setpoint may be increased again by a predetermined amount (method element 63), until the NOx levels are stable. To perform the stability portion of the algorithm it may be necessary to run a scheme that uses filtering and debounce timers to indicate when the NOx knee or the CO knee are being approached. The new O₂ voltage setpoint at which the NOx levels are stable may then be saved (method element 71). The O₂ voltage setpoint may be skewed a calibrated value either upward or downward to maintain a setpoint just rich of the NOx knee in the lambda curve (method element 73). The calibrated value may be determined for each engine. At that point the process may end (method element 75) and may be restarted upon the detection of a change in condition or after a predetermined period of time has elapsed. Method elements 55-69 comprise a lean lambda sweep 77.

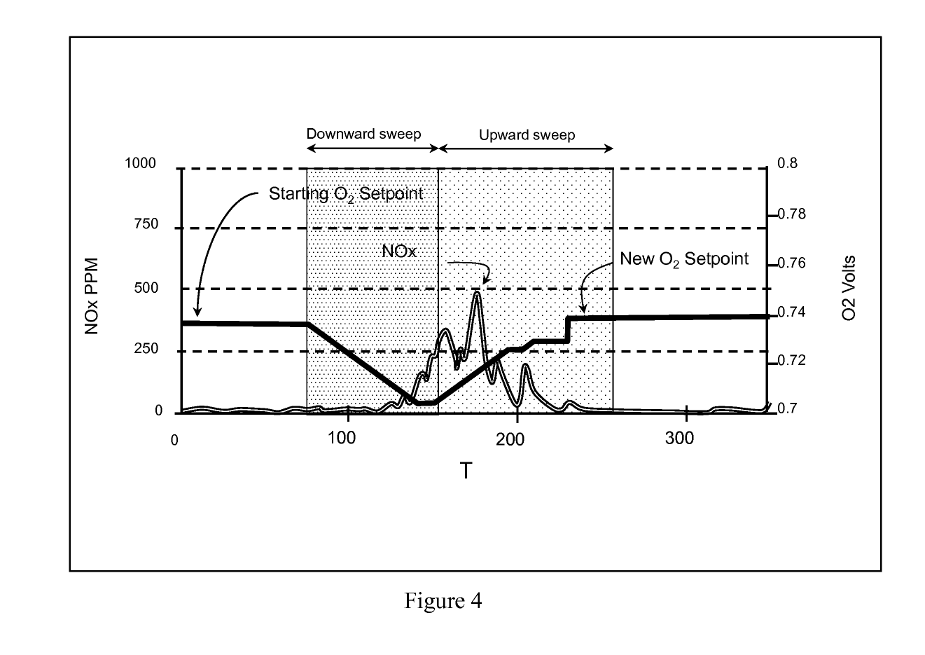

The principle behind the method for setting a new O₂ voltage setpoint for NOx compliance 50. is best illustrated with reference to FIG. 4. FIG. 4 is a chart that plots measurements of NOx concentrations (double line) for varying O₂ voltage setpoints (solid line) over time. The O₂ voltage setpoint is decreased at a predetermined rate from a starting O₂ voltage setpoint in the downward sweep of the method. As the O₂ voltage setpoint is decreased, a stability threshold is breached when the NOx concentration spikes upward. At that point the O₂ voltage setpoint is increased at a pre-determined rate in the upward sweep until the NOx levels decrease and become stable. The new O₂ voltage setpoint is set at the level where the NOx emissions are stable.

The internal combustion engine system 1 may be used for operating an engine at an optimum O₂ voltage setpoint for NOx and CO compliance. NOx sensor 45 may be used to provide an indication of CO concentration that is represented as an increase in the NOx ppm output as the rich knee of the lambda curve is approached. The CO concentration in on the rich side appear to create stable interference in the NOx sensor 45resulting in a NOx reading. This anomaly is caused by ammonia creation at extreme rich levels which is reported as NOx concentration by the NOx sensor 45.

Using both a lean and rich stability detection algorithm with this anomaly, it is possible to develop a method for setting a new O₂ voltage setpoint for NOx and CO compliance. This is accomplished by performing a lambda sweep (i.e. sweeping the O2 voltage setpoint))to verify both locations of the lean and rich knees on the lambda curve. The O₂ voltage setpoint may then be readjusted to a value at a point between the lean and rich knees to achieve lower NOx and CO catalyst out emissions in the optimal part of the emissions curve.

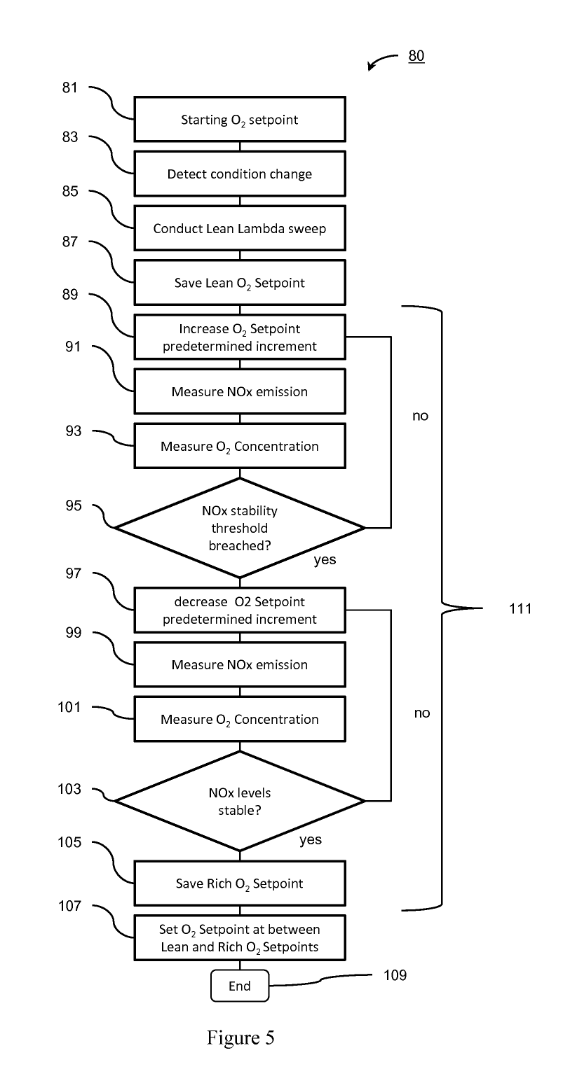

FIG. 5 illustrates an embodiment of a method for setting a new O₂ voltage setpoint for NOx and CO compliance 80 that may be carried out by the emission control module 47. In this method it is assumed that the internal combustion engine system 1 is operating at a starting O₂ voltage setpoint (method element 81). Upon the detection of a condition change (method element 83), the emission control module 47 may initiate a lean a lambda sweep (method element 85) (e.g. sweeping the operation of the engine to a lean O2 voltage setpoint in the direction of the lean knee of FIG. 2, resulting in a lean engine lambda). The lean lambda sweep is more specifically described as reference 77 in FIG. 3. The lean O₂ voltage setpoint is saved in method element 87, and a rich lambda sweep is initiated (e.g. sweeping the operation of the engine to a rich O2 voltage setpoint in the direction of the rich knee of FIG. 2, resulting in a rich engine lambda) with the increase of the O₂ voltage setpoint by a predetermined increment (method element 89). The NOx emissions and O₂ concentrations are measured in method element 91 and 93 respectively. A determination of whether the NOx stability threshold on the rich side of the lambda curve has been breached is then made (method element 95). As described before the stability threshold is breached when the NOx levels spike. If the NOx stability level has not been breached then the O₂ voltage setpoint is increased again by a predetermined increment (method element 89). If the NOx stability level has been breached then a downward sweep of the O₂ voltage setpoint is initiated by decreasing the O₂ voltage setpoint a predetermined increment (method element 97). NOx emissions and O₂ concentrations are measured in method element 99 and 101 respectively. The emissions control module 47 then determines whether the NOx levels have become stable (method element 103). If the NOx levels are not stable, the emissions control module 47 again instructs a decrease of the O₂ voltage setpoint by a predetermined increment (method element 97). If the NOx levels are stable the rich O₂ voltage setpoint is saved (method element 105), and the O₂ voltage setpoint is set at a level between the saved lean and rich O₂ voltage setpoints (method element 107). The iteration of the method is then completed (method element 109. The method elements 89 through 105 may be designated as the rich lambda sweep 111. The O2 voltage setpoint increments and decrements described herein may be changed by a predetermined amount or by a predetermined sweep rate or until the NOx sensor reads a predetermined threshold concentration, or some other method.

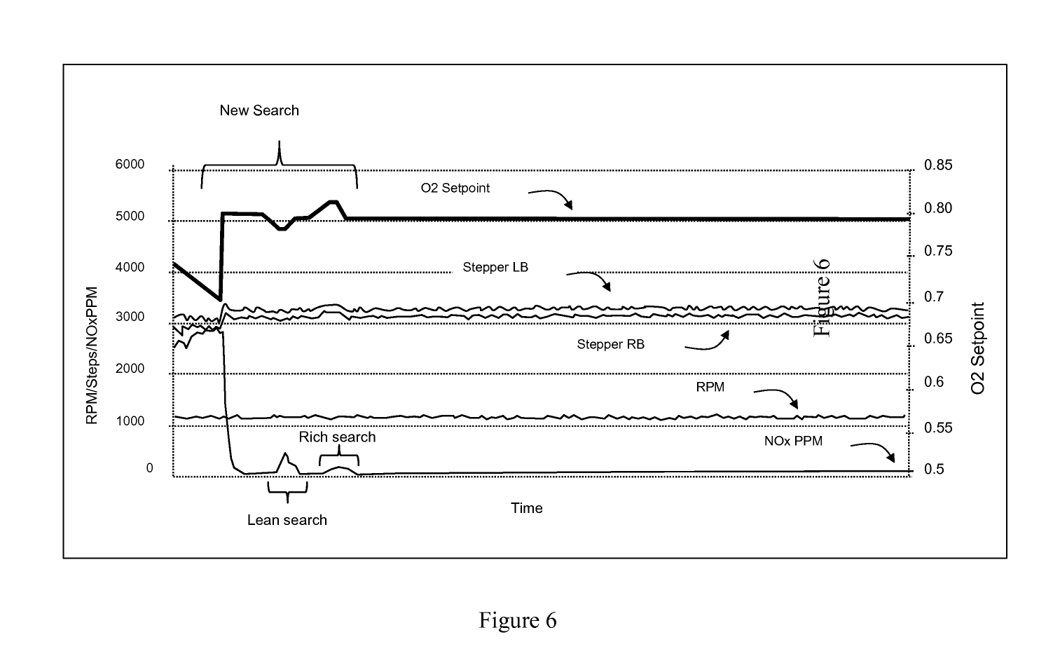

The principle of a method for setting a new O₂ voltage setpoint for NOx and CO compliance 80 is best illustrated with reference to FIG. 6. FIG. 6 is a chart that plots measurements of NOx concentrations (the bottom curve) and the O₂ voltage setpoint is (top solid curve). Also illustrated in the chart in FIG. 6 are the engine RPM and the signals to the right regulator 33 and the left regulator 35, denoted as stepper RB and stepper LB. A new search is initiated by decreasing the O₂ voltage setpoint until the stability threshold is breached (spike in NOx for lean search), and then increasing the O₂ voltage setpoint until the NOx readings become stable again. The O₂ voltage setpoint is increased until the stability threshold is breached, and then decreased until the NOx levels become stable again. At that point the emission control module has an O2 voltage setpoint value determined by the lean search and an O₂ voltage setpoint value determined by the rich search. These values correspond the rich knee and the lean knee of the lambda curve. The desired O₂ voltage setpoint for the operation of the internal combustion engine system 1 would typically fall between the two O₂ voltage setpoints, and optionally may be set at the midpoint between these O₂ voltage setpoints to achieve the lowest NOx and CO catalyst out emissions in the optimal part of the emissions curve.

If at any time the lambda sweep routine is not able to detect the knee(s) on the curve(s), a new sweep may be performed to retry the setpoint optimization. Reasons for not detecting optimal setpoints could include; changes in fuel composition, large changes in humidity, other environmental conditions, or degrading of catalyst performance. Optionally emission control module 47 may be programmed to periodically re-establish the optimum setpoint to the left of the knee. This is done as these optimum points will shift due to changes in operating and/or environmental conditions.

The internal combustion engine system 1 provides NOx and CO compliance over a wider range of operating conditions, including environmental and catalyst window shift conditions by providing periodic automatic resetting of the O₂ setpoints. Additionally, because of the continuous measurements taken over time, emission control module 47 may log emissions performance and emissions compliance status. Another option that may be added to the emission control module 47 would include the addition of shut down instructions if the internal combustion engine system 1 is not in compliance with emission regulations.

While the methods and apparatus described above and/or claimed herein are described above with reference to an exemplary embodiment, it will be understood by those skilled in the art that various changes may be made and equivalence may be substituted for elements thereof without departing from the scope of the methods and apparatus described above and/or claimed herein. In addition, many modifications may be made to the teachings of above to adapt to a particular situation without departing from the scope thereof. Therefore, it is intended that the methods and apparatus described above and/or claimed herein not be limited to the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another. Furthermore, it should be emphasized that a variety of computer platforms and control modules and operating systems are contemplated.

What is claimed:

1. A method of operating an internal combustion engine over a range of operating conditions, the internal combustion engine having at least one O₂ sensor, the method comprising:
operating the engine at an initial O₂ voltage setpoint;
automatically adjusting the O₂ voltage setpoint to a new O₂ voltage setpoint to reduce emissions.

2. The method of claim 1 wherein the method element of automatically adjusting the O₂ voltage setpoint to reduce emissions comprises incrementally decreasing the O2 voltage setpoint from a high setpoint to a low setpoint until measurements of NOx become unstable and incrementally increasing the O₂ voltage setpoint until measurements of NOx become stable.

3. The method of claim 2 wherein the method element of incrementally decreasing the O₂ voltage setpoint comprises decreasing the O₂ voltage setpoint at a predetermined sweep rate.

4. The method of claim 2 wherein the method element of incrementally increasing the O₂ voltage setpoint comprises increasing the O₂ voltage setpoint at one of a predetermined sweep rate and a predetermined O₂ voltage setpoint amount.

5. The method of claim 1 further comprising adjusting the O₂ voltage setpoint in response to one of a change in operating conditions and a timer.

6. The method of claim 5 wherein the change in operating conditions comprises a change in operating conditions chosen from the group including a new load on the engine, a new engine speed, new ambient conditions; degradation of the catalyst and an operating time interval.

7. The method of claim 1 further comprising:
sensing an O₂ content of the exhaust;
sensing a NOx content of the exhaust; and
wherein the method element of automatically adjusting the O₂ voltage setpoint comprises:
incrementally decreasing the O₂ voltage setpoint until the NOx content becomes unstable; and
incrementally increasing the O₂ voltage setpoint until the NOx content becomes stable.

8. A system for improving emission performance of an internal combustion engine over a range of operating conditions, comprising:
a catalyst subsystem for treating exhaust from the internal combustion engine;
an O₂ sensor disposed upstream from the catalyst subsystem;
a NOx sensor disposed in the exhaust; and
a control subsystem that receives data from the O₂ sensor and the NOx sensor, and automatically adjusts an O₂ voltage setpoint to a new setpoint to reduce emissions.

9. The system of claim 8 wherein the control subsystem further comprises a control subsystem that incrementally adjusts the O₂ voltage setpoint from a high setpoint to a low setpoint until a NOx stability level is breached; and incrementally increases the O₂ voltage setpoint until NOx measurements become stable.

10. The system of claim 8 wherein the control subsystem that incrementally adjust the O₂ voltage setpoint comprises a control subsystem that adjusts the O₂ voltage setpoint at one of a predetermined sweep rate and a predetermined O2 setpoint amount.

11. The system of claim 8 wherein control subsystem automatically adjusts the O2 voltage setpoint in response to a change in the operating conditions the change in operating conditions comprising at least one of anew load on the engine; a new engine speed; new ambient conditions; a new fuel quality and an operating time interval.

12. A control system for controlling emissions in an internal combustion engine exhaust comprising:
at least one subsystem that controls an O₂ voltage setpoint;
at least one subsystem that measures NOx emissions in the engine exhaust; and
at least one subsystem that initiates a lambda sweep to determine an optimal O₂ voltage setpoint.

13. The control system of claim 12 wherein the subsystem that initiates the lambda sweep comprises:
a subsystem that decreases the O₂ voltage setpoint until a NOx stability threshold is breached; and
a subsystem that increases the O₂ voltage setpoint until NOx emissions in the engine exhaust become stable.

14. The control system of claim 12 further comprising at least one subsystem that sets the O₂ voltage setpoint to the optimal setpoint.

15. The control system of claim 12 wherein the subsystem that initiates a lambda sweep comprises at least one subsystem that initiates a lean lambda sweep; and at least one subsystem that initiates a rich lambda sweep.

16. The control subsystem of claim 15 wherein the subsystem that initiates a lean lambda sweep comprises:
at least one subsystem that incrementally decreases the O₂ voltage setpoint until the NOx emissions become unstable; and
at least one subsystem that incrementally increases the O₂ voltage setpoint until the NOx emissions become stable.

17. The control subsystem of claim 15 wherein the subsystem that initiates a rich lambda sweep comprises:
at least one subsystem that incrementally increases the O₂ voltage setpoint until the NOx emissions become unstable; and
at least one subsystem that incrementally decreases the O₂ voltage setpoint until the NOx emissions become stable.

18. The control subsystem of claim 12 wherein the subsystem that initiates a lambda sweep comprises:
at least one subsystem that initiates a lean lambda sweep to determine a lean O₂ voltage setpoint
at least one subsystem that initiates a rich lambda sweep to determine a rich O₂ voltage setpoint; and
at least one subsystem that determines an O₂ voltage setpoint between the lean O₂ voltage setpoint and the rich O₂ voltage setpoint.

19. A method for controlling emissions in an internal combustion engine exhaust comprising”measuring NOx emissions;
initiating a lambda sweep to determine an O₂ voltage setpoint at which NOx emissions at the new operating condition comply with NOx emissions standards; and
operating the internal combustion engine at the new O₂ voltage setpoint.

20. The method of claim 19 further comprising initiating a lambda sweep to determine an O₂ voltage setpoint at which CO emissions at the new operating condition comply with CO emissions standards

21. The method of claim 19 wherein the method element of initiating a lambda sweep comprises
incrementally decreasing the O₂ voltage setpoint until the NOx emissions become unstable; and
incrementally increasing the O₂ voltage setpoint until the NOx emissions become stable.

22. The method of claim 20 wherein the method element of initiating a lambda sweep comprises incrementally increasing the O₂ voltage setpoint until the NOx emissions become unstable ; and a incrementally decreasing the O₂ voltage setpoint until the NOx emissions become stable

23. One or more computer-readable media having computer-readable instructions thereon which, when executed by a control module that controls emissions in an internal combustion engine exhaust, cause the control module to:
measure NOx emissions;
initiate a lambda sweep to determine an O₂ voltage setpoint at which NOx emissions at the new operating condition comply with NOx emissions standards; and
operate the internal combustion engine at the new O₂ voltage setpoint.

24. The one or more computer readable media of claim 23, which further cause the control module to initiate a lambda sweep to determine an O₂ voltage setpoint at which CO emissions at the new operating condition comply with CO emissions standards

25. The one or more computer readable media of claim 24 wherein the instructions that cause the control module to initiate a lambda sweep comprises instructions that cause the control module to
incrementally decrease the O₂ voltage setpoint until the NOx emissions become unstable; and
incrementally increase the O₂ voltage setpoint until the NOx emissions become stable.

26. The one or more computer readable media of claim 24 wherein the instructions that cause the control module to initiate a lambda sweep comprises instructions that cause the control module to
incrementally increase the O₂ voltage setpoint until the NOx emissions become unstable; and
incrementally decrease the O₂ voltage setpoint until the NOx emissions become stable.
